(19) United States
(12) Patent Application Publication
(10) Pub. No.: US 2005/0260873 A1
(43) Pub. Date: Nov. 24, 2005

(54) Terminal

(76) Inventors: Zhi Ping Zheng, Hong Kong (CN); Wai Kai Woo, Hong Kong (CN)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/016,359

(22) Filed: Dec. 17, 2004

(30) Foreign Application Priority Data
Feb. 10, 2004 (CN) 2004200012975

(51) Int. Cl. H01R 13/44

(52) U.S. Cl. 439/125

(57) ABSTRACT

This utility model introduces a new kind of terminal which is comprised of three parts. The upper part is for display and operation, the middle part is for support and the lower part is for movement and support. It is characterized in its structure of board of all the mentioned three parts with supporting wheels in the lower part. The mentioned upper part is installed with flat displayer and touch screen, while the mentioned middle part is installed with the mainframe of the computer and the mentioned lower part is installed with power source. This practical and new terminal features good flexibility and can be used as the management terminal of industrial production workshop.

### TECHNICAL FIELD

This utility model concerns a kind of terminal.

### BACKGROUND ART

Traditional terminal has a structure of outer appearance of square column or the column of other types with its upper part installed with a displayer, usually CRT displayer. The size of such kind of terminal is relatively large with a bulky shape and will only be placed in a specific location, and not to be moved easily.

In addition, such terminal is mainly used for the purpose of inquiry and display and is not applicable in the workshop production monitoring, production instruction arrangement and automatic feedback of production result in the manufacturing industry; hence is relatively less practicability.

### Contents of the Utility Model

This utility model is therefore aimed at providing a terminal of high flexibility, namely, being small in size and light in weight.

For this purpose, this utility model adopts a simple streamline design and a light and handy size to deflate the clumsy image of terminals. Its main idea is to meet the different needs of users by virtue of slim body design and irregular shapes.

Specifically, the functional objective of this utility model is to be realised by such kind of terminal which is comprised of three parts, of which the upper part is for display and operation, the middle part is for support and the lower part is for movement and support. It is characterized in that a structure of board of all the mentioned three parts with supporting wheels in the lower part, of which the mentioned upper part is installed with flat displayer and touch screen, while the mentioned middle part is installed with mainframe of the computer and the mentioned lower part is installed with power source.

The priority implementation scheme of this utility model can also include the following technical features or their combination. For example, the upper part of the terminal can be slanting backward and the terminal can be placed 50 degrees of angle to the horizontal plane. This design caters for the needs of users when entering data and watching the screen. The upright part of the middle part can house the mainframe of the computer, electronic control equipment and power source accessories and be used as a supporting framework of the upper half part. The part of lower half can be designed to be in Z shape mainly for the purpose of increasing stability of the terminal and supporting the components and parts over it. Finally, supporting wheels can be added to the terminal mainly for the purpose of using the terminal in different places and to facilitate its portability.

The further objective of this utility model is to enhance the practicability of the terminal. For this reason, apart from being installed with the components of inquiry and display, the terminal can be installed with other parts to increase its practicability. For example, electronic data identification device, web camera, wireless network device and RS-232 port can be added for the purpose of information entry, data processing and transmission of documents. In order to help reduce the size of the terminal itself, the new terminal can be equipped with LCD to replace traditional CRT displayer, while touch screen as a replacement for mouse and keyboard for the purpose of data entry and inquiry.

### DRAWINGS

The specific implementation of this utility model is explained together with the following drawings. In the drawings attached:

FIG. 1 is the front view of the prioritized implementation scheme of the terminal of this utility model;

FIG. 2 is the profile of the terminal shown in FIG. 1.

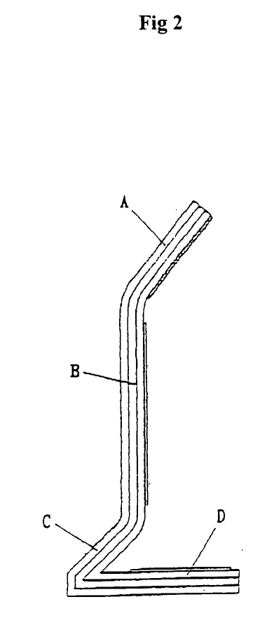

### SPECIFIC MODE FOR CARRYING OUT THE UTILITY MODEL

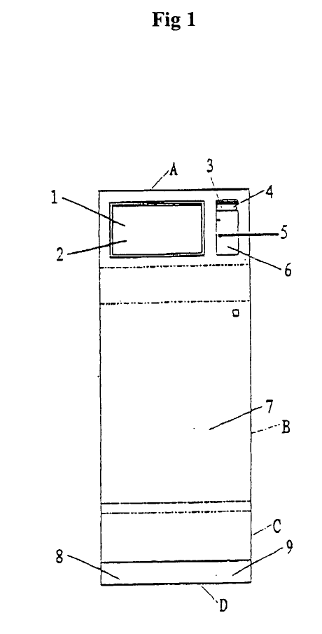

As FIG. 1 shows that this terminal of the utility model terminal is comprised of upper, middle and lower parts with Upper Part A primarily being the part of display and operation, Middle Part B primarily being the part of support and the lower part being the part of movement and support. Each part also includes driving circuit of the terminal. It is characterized by a structure of board for all the three parts mentioned.

Because of adopting the structure of board, this terminal of utility model has the feature of a smaller volume, lighter weight and more appealing designs.

As one of the prioritized implementation examples of this utility model shows that the mentioned Upper Part A is better to be slanting backward to enable the viewer to observe with a good vision angle for viewing. The angle between Upper Part A and the horizontal plane is better to be 0-60 degree, e.g. 50 degrees.

In addition, in order to help stabilize the placement of terminal without other devices, the lower part can be designed to be in the shape of letter Z, that is, this lower part includes a slanting part C and a horizontal part D. On the horizontal part D, supporting wheels can also be installed to enable the use of the terminal in different places with easier portability.

The displaying part of the mentioned Upper Part A can be either LCD 1 or other flat board-shaped displayer, e.g. plasma displayer. As the part for entry, the mentioned upper part can include touch screen 2, mainframe of the computer 7 can be installed in the mentioned middle part and power source can be installed in the mentioned lower part. Power source is better to be uninterrupted power source 9.

Electronic identification device 6 and the LCD displayer 3 for this electronic identification device can be installed in the mentioned middle part. The said electronic identification device 6 can be magnetic induction reader, IC card reader, fingerprints identification device or their combination.

Wireless network device 4 can also be installed in the mentioned upper part for wireless connection of the terminal. Network camera 5 can also be installed in the mentioned upper part.

RS-232 port 8 can be installed in the mentioned lower part for connection with the main control equipment such as numerical control equipment or processing centre, etc.

What needs to be explained is that the key of this utility model lies in the overall structure of the terminal. The electrical connection of various components and the connection of signal lines of the terminal fall in the field of conventional technology. Ordinary technicians in this field will know how to connect with the mentioned components by use of conventional technologies after reading this description.

Details of each component mentioned are introduced as follows. Though the following introduction will explain on the components one by one, it is apparent as mentioned that the realisation of the objective of this practical new model does not require all of these components.

1. LCD displayer

Traditional CRT displayer has a relatively larger size and occupies more space. The size affects its dissipation of heat, meanwhile, regular terminals have to be designed in a larger size so as to match with CRT displayers of which the size of CRT displayer is larger. If user uses CRT displayer for a long period of time, the radiation of CRT displayer tends to make the user easily feel dizzy. Therefore, the advantage of the slimmer body of LCD is used to replace traditional CRT displayer in order to reduce the size of the terminal. As the space occupied is reduced, the problem of dissipation of heat is also eased, enhancing the application of the terminal.

As far as practicality is concerned, apart from being used for display in general, LCD will be regarded as an important means in the replacement of traditional paper in the distribution of technical information in the application of industrial production and in the machine manufacturing industry in particular. It is because that LCD will be regarded as an important part of the paperless production process. The utilization of LCD with the support of proper computer-managed system can show relevant technical drawings in place of repetitive and time-consuming work of manual arrangement, photo-copying and circulation of documents. As a result, the problems of security and management of technical information thus caused can also be solved.

2. Touch Screen

Traditional mouse and keyboard require designing for placement and is inappropriate to be used in the environment that gets dirty easily because of the restriction of the equipment itself. If applied in industry, the terminal will be placed and used in the workshop which gets dirty easily. Machine oil or scraps may be trapped inside the mouse and keyboard in the process of data input, damaging components of the mouse and keyboard. We will use touch screen in stead of mouse and keyboard because touch screen occupies smaller area than that occupied by the mouse and keyboard, on the other hand, touch screen is mainly installed within the terminal and easily housed. Problem of placement and cleaning can be solved further as plastic rims are added along the edges to prevent dirt from entering the inside of the terminal, one can solve the problem of placement and keeping it clean.

As far as flexibility is concerned, the use of touch screen as human-machine information input port helps abandon mobile input port like the mouse and others and therefore enhances the overall flexibility of the terminal.

From the practicality point of view, touch screen can not only replace the mouse in operating movements in general processes but also has the function of data input as the keyboard does. As the terminal is used in workshop and less information in form of text is entered, operating processes provided by the system will be used for information input by means of touch screen, and level of application increases.

3. LCD Displayer

Traditional terminals do not include this part. LCD displayer is mainly used for the security function of support of the terminal log-in, in cancellation and displaying of relevant information. For this reason, it should be small in size, easy for installation and repair, and should be installed in a visible position and placed together with the device of log-in and cancellation (electronic data identification device).

In terms of practicalities, LCD has a built-in microprocessor control component, which plays a role of monitoring the security of the whole set of terminal, sending real-time feedback to the operator without the process of server in order to raise the efficiency of data processing. When in use, the component will monitor and display the log-in of the terminal by authorised person based on the list of authorized users and their respective time-slots of access default in the microprosessor so as to prevent unauthorized persons from using the terminal. At the same time, it displays the security information of log-in and cancellation by the operator, enabling him or her to understand the current status of use.

4. Wireless Network Device

From the mechanical point of view, wireless network signal receiver replaces traditional network line by connecting with wireless LAN to send and receive electronic data in a wireless manner. As it is difficult to repair network cable pre-laid, an increase in the number of users will give rise to the difficulty of adding network cables. Moreover, too many network cables require extra equipment and extra repair charge, being detrimental to the mobile use of terminals. Wireless network device therefore will be used as the equipment of network connection and the wireless network device needs to be small in size and easy for installation and repair.

As far as practicalities is concerned, wireless network device is mainly used as a bridge of transmitting information between the terminal and the server. It adopts the international standard 802.11b protocol for wireless network structure to perform the work such as data exchange and decision-making operation through ACCESS POINT, the wireless visit segment point equipment, wireless network device (WNIC) by way of WI-FI technology. Wireless network device has unique advantage in a wide range of domains of application: the first is mobility, providing the application without the restriction of cable to the effect that a user can access the network at any time; second, it is easy to install and does not require laying of cable, substantially saving the time of network construction; third, it is flexible for network formation, namely immediate use upon insertion, and the network manager can quickly put it into the existing network and enable its operation in certain environment; fourth, it is low in cost, particularly suitable for the place of production workshop which changes frequently.

Furthermore, wireless network is relatively safe as wireless network communication uses air as its medium and the signal transmitted by it can stride over a very broad band of frequency and is very similar to the noise of natural background. As a result, it is difficult for a wiretapper to tap data in ordinary manner. “Encryption” is also an essential aspect of wireless network as it enhances security effectively. All wireless network can have security code so that even though a wiretapper succeeds in receiving data with every effort, he cannot open the information system without the code.

5. Network Camera

From the flexibility point of view, network camera component is mainly used as the function of video communication connection, creating an exchange platform of video information at each mobile control point within a large coverage. It should have the function of video conferencing between multi-parties, and network camera therefore needs to be small in size and easy for installation and repair and be placed in a fixed position of the right upper part of the terminal to facilitate mobile operation.

As far as practicality is concerned, network camera mainly provides real-time video communication feature such as receiving outer appearance information of target object, remote inspection of manufactured part and video conference of technology. As a result, network camera enables people in different places to understand current circumstances and solve problems in a timely manner by way of connection. In addition, network camera has the function of photographing and e-mail delivery, enabling photographing and video transmission and hence enlarging the scope of information to be sent and enhancing the quality of content.

In addition to the above, network camera can also help perform security log-in function. When an operator performs log-in, the network camera can take the picture of the operator for identification.

6. Electronic Data Identification Device

Electronic data identification device can be regarded as electronic data input device, which is mainly comprised of combined modules. The major purpose of the device is for electronic data security verification, of which replaceable components will include magnetic induction reader, IC card reader, fingerprints identification device, etc. Each component will shoulder different functions of security verification to meet the needs of different application conditions, of which:

Magnetic Induction Reader

In terms of mechanism, due to limitation in inquiry and display, ordinary terminals do not include magnetic induction reader while the new terminal will have this component, an initiative which cannot only use the terminal for ordinary data inquiry, but also for electronic data input, log-in and verification, increasing the scope of use. This magnetic induction reader therefore needs to be small in size and strong in receiving capability, together with the handy design of its body to increase its flexibility and applicability and to integrate its various functions.

In terms of practicality, magnetic induction reader is mainly used for frequent and relatively simple data input with a lower level of security requirement. As it is limited to reading information only, magnetic induction reader will be used as part of electronic data input and log-in and its function should match the corresponding IC magnetic induction card. Because relevant information will be saved on IC magnetic induction card in advance, when chip magnetic induction card is placed on the reader, the information on the IC chip will be read and processed. Such a process can reduce repetitive input, increase efficiency and lower the chances of manual errors.

IC Card Reader

The main purpose of use of IC card reader can also be regarded as the same as that of magnetic induction reader, but the former can re-write data apart from being able to read them, therefore it can be used to meet requirement of higher security level, such as for transaction processing and flow recording, etc.

Fingerprints Identification Device

The last one is fingerprints identification device. As this device is operated as an identification function through biological characteristics examination, its level of security is the highest. It is mainly used as a function of reinforced security log-in. If magnetic induction reader or IC card reader is used with fingerprints identification device, an operator has, on one hand to perform the input and re-writing of personal data reading through IC magnetic induction card or IC card, and the identity of the operator can be verified by the fingerprints identification device on the other. This helps avoid accidental loss of IC magnetic induction card or IC card or information disclosure, and the protection of sensitive information can be reinforced.

7. Mainframe of the Computer

In realizing the flexibility of the terminal, the appearance of the terminal is small and handy. So, the size of computer is also limited. As slim-sized computers required and available in the market are few, the body of the mainframe of the computer for this terminal should not exceed 50 mm in thickness in order to enhance its overall mobility.

As far as practicality is concerned, the computer is used as an intermediate data and information exchange and processing centre between production equipments and the production management system. It has a software application system on its own, which will feedback the result of processing by production equipments to the small database of the terminal. The processed result will further be sent to the server for processing planning. Meanwhile, it utilises the self-carried database of the computer of the terminal to process and analyse the production instruction sent by the server. At the same time, it sends production instruction to production machines for processing and production by connection of signal channels.

8. RS-232 Port

Wireless terminal is an integrated part of the entire electronic workshop management. Its major function is to send relevant data to production machines through the wireless network and also to feedback the result of production to the server. RS-232 port of the terminal is mainly used to connect with the production equipments controlled by the main computer. Terminal applied in manufacturing industry will be connected with numerical control equipment processing centres, etc. in order to collect corresponding production information.

9. Uninterrupted Power Source

As far as flexibility is concerned, uninterrupted power source mainly provides stable supply of power to the terminal, and therefore uninterrupted power source needs to be placed near to the power supply. Due to the restriction of the shape of the terminal, uninterrupted power source has to be small in size and easy for installation and repair.

In terms of practicalities, the major use of uninterrupted power source is to maintain the stability of power supply. When power supply is cut off, the power source can maintain power supply for a period of time, enabling the timely storage of data and information and loss can be avoided.

1. A terminal comprised of three parts. The upper part is for display and operation, the middle part is for support and the lower part is for movement and support. It is characterized in that a structure of board of all the mentioned three parts with supporting wheels in the lower part. The mentioned upper part is installed with flat displayer and touch screen, while the mentioned middle part is installed with the mainframe of the computer and the mentioned lower part is installed with power source.

2. The terminal as described in claim 1 is characterized in a backward slanting of the mentioned upper part.

3. The terminal as described in claim 2 is characterized in a 0-60 degree of angle between the mentioned upper part and the horizontal plane.

4. The terminal as described in claim 3 is characterized in the mentioned angle of 50 degrees.

5. The terminal as described in claim 2 is characterized in the Z-shaped lower part.

6. The terminal as described in claim 1 is characterized in the Z-shaped lower part.

7. The terminal as described in claim 1 is characterized in that the mentioned upper part installed with an electronic data identification device and the LCD screen for this electronic data identification device.

8. The terminal as described in claim 7 is characterized in that the mentioned electronic data identification device includes at least one of the following devices: magnetic induction reader, smart card reader and fingerprints identification device.

9. The terminal as described in claim 1 is characterized in that the mentioned upper part installed with a wireless LAN card.

10. The terminal as described in claim 1 is characterized in that the mentioned upper part installed with a network camera.

11. The terminal as described in one of claims 1 to 6 claim 1 is characterized in that the mentioned lower part installed with a RS-232 port for the use of connection with the main control equipment.
